(19) United States
(12) Patent Application Publication
(10) Pub. No.: US 2018/0009698 A1
(43) Pub. Date: Jan. 11, 2018

(54) METHOD FOR REFORMING GLASS TUBES INTO GLASS SLEEVES

(71) Applicant: CORNING INCORPORATED, CORNING, NY (US)

(72) Inventors: Allan Mark Fredholm, Vulaines sur Seine (FR); Raymond ChihChung Hsiao, Painted Post, NY (US); Boris Nikolayevich Tsvetkov, Leningrad (RU)

(21) Appl. No.: 15/545,569

(22) PCT Filed: Jan. 26, 2016
(86) PCT No.: PCT/US2016/014842

§ 371 Date: Jul. 21, 2017

(51) Int. Cl. C03B 23/045; C03B 23/06

(52) U.S. Cl. CPC C03B 23/045; C03B 23/06

(57) ABSTRACT

A method for producing a glass sleeve having a first flattened portion and shaping tools for forming such glass sleeves. A method can comprise providing a substantially cylindrical glass tube—optionally polished or otherwise treated to reduce or remove interior imperfections—heating the glass tube to a temperature within the softening range of the glass, introducing one or more shaping tools having a generally D-shaped or generally rectangular cross-section into the enclosed space, and moving the one or more shaping tools against the inner curved surface to deform the tube, forming the first flattened portion. The one or more shaping tools can be made of any suitable material, for example: steel coated with boron nitride; porous graphite or carbon air bearings; or a nickel-based alloy (e.g., Inconel).

This application claims the benefit of priority under 35 U.S.C. §119 of U.S. Provisional Application Ser. No. 62/107,598 filed on Jan. 26, 2015 the content of which is relied upon and incorporated herein by reference in its entirety.

### FIELD

The present disclosure generally relates to manufacture of three-dimensional (3D) glass articles.

### BACKGROUND

A glass panel is often used as a front cover for an electronic device, for example a cellular telephone or smart phone. Electronic device manufacturers now desire back covers of electronic devices that are also made of glass and that meet the same high dimensional accuracy and surface quality as the front covers. Although it is possible to make the front and back covers separately with the requisite dimensional accuracy and surface quality and then assemble each with a case, this adds extra steps to the manufacturing process and can result in loss of dimensional control.

Methods for forming glass tubing from molten glass are known. The most common ones are the Danner process, the Vello process, and the downdraw process. These processes are described in, for example, Heinz G. Pfaender, “Schott Guide to Glass,” 2nd ed., Chapman & Hall, 1996. These processes are typically used to form glass tubing with a round cross-sectional shape. Extrusion can be used to form glass tubing with a non-round cross-sectional shape, e.g., a cross-sectional shape that could have flat sides. However, extrusion involves tool contact with the glass surface, which could diminish the surface quality of the glass. Non-round extrusions are harder to polish or otherwise post-treat to remove imperfections than are round extrusions, so the imperfections introduced by extrusion persist in the finished product. Current approaches have been limited by the quality of the products or by extremely low manufacturing speeds.

There is no commercially available high quality reforming method to produce a high quality shaped glass sleeve from a pre-existing high quality glass tube. Current approaches have been limited by the quality of the products or by extremely low manufacturing speeds. There is a need for an in-line glass manufacturing process to make high quality shaped glass sleeves.

### SUMMARY

The present disclosure relates generally to glass sleeves and shaping tools for forming such glass sleeves.

Optionally, a method for producing a glass sleeve with a first flattened portion can comprise the steps of: providing a substantially cylindrical tube made of glass, the substantially cylindrical tube having a longitudinal axis and an inner curved surface enclosing a space; optionally polishing or otherwise treating the tube to reduce or remove interior imperfections, exterior imperfections, or both; heating the substantially cylindrical tube to a temperature within the softening range of the glass; introducing one or more shaping tools having a generally D-shaped or generally rectangular cross-section into the enclosed space; moving the one or more shaping tools against the inner curved surface to deform the tube, forming the first flattened portion. Optionally, at least two shaping tools can be introduced into the enclosed space and moved apart from each other and against the inner curved surface. The one or more shaping tools can be moved against the inner curved surface to deform the tube and form two opposing flattened portions. One or more shaping tools having a generally rectangular cross-section can be moved against the inner curved surface to deform the tube and form two pairs of two opposing flattened portions. Alternatively, one or more shaping tools having a generally D-shaped cross-section can be moved against the inner curved surface to deform the tube and form two opposing curved portions. The two opposing curved portions can be substantially semi-circular.

The generally D-shaped section can comprise: a generally half-cylindrical, convex front portion mounted for movement against the inner curved surface; circumferentially spaced, axially extending first and second side portions on opposite sides of the front portion; a first following portion extending back from the first side portion along a plane generally parallel to the direction of movement of the front portion; and a second following portion extending back from the second side portion generally parallel to the direction of movement of the front portion.

The substantially cylindrical tube can be heated to a temperature such that the glass temperature exceeds either the dilatometric softening point of the glass or the Littleton softening point of the glass. The substantially cylindrical tube can be heated to a temperature such that the glass viscosity is 10⁷-10^{9.5} P (poise). The substantially cylindrical tube can have a length along the longitudinal axis and the one or more shaping tools can be moved against the inner curved surface at a force of 0.5-10.0 N per cm length of the substantially cylindrical tube.

The one or more shaping tools can be made of any suitable material, for example: steel coated with boron nitride; porous graphite or carbon air bearings; or a nickel-based alloy (e.g., Inconel).

Optionally, a glass sleeve can comprise a substantially rectangular or substantially oval cross-section, a length, an internal opening, and a glass thickness; the cross-section optionally can have at least a first flattened portion, wherein the flatness of the first flattened portion does not deviate by more than 50 μm across the length. Optionally, the glass thickness does not vary by more than 50 μm across the first flattened portion. Optionally, the internal opening does not vary by more than 100 μm across the first flattened portion. The cross-section can further comprise a second flattened portion opposing the first flattened portion to define a first pair of opposing flattened portions. The cross-section can further comprise a second pair of opposing substantially flattened portions. The first and second pairs of opposing substantially flattened portions can define a generally rectangular cross-section. Alternatively, the cross-section can comprise a pair of opposing curved portions. The opposing curved portions can be substantially semi-circular. Other shapes of the tube, such as substantially triangular or substantially hexagonal with rounded corners, are also contemplated,

Additional features and advantages of the present disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF SEVERAL VIEWS OF THE DRAWINGS

The following is a description of the figures in the accompanying drawings. The figures are not necessarily to scale, and certain features and certain views of the figures may be shown exaggerated in scale or in schematic in the interest of clarity or conciseness.

FIG. 1A is a top plan view of a generally D-shaped cross-section shaping tool.

FIG. 1B is a perspective view of the shaping tool of FIG. 1A.

FIG. 2A is a top plan view of a generally rectangular shaping tool.

FIG. 2B is a perspective view of the shaping tool of FIG. 2A.

FIG. 3 is a perspective view of a glass sleeve formed by a shaping tool.

FIG. 4 is a perspective view of another glass sleeve formed by a shaping tool.

FIG. 5A schematically represents two of the shaping tools depicted in FIGS. 1A and 1B in contact with the inner curved surface of a glass tube, prior to deformation.

FIG. 5B schematically represents two of the shaping tools depicted in FIGS. 1A and 1B in contact with the inner curved surface of a glass tube (now a glass sleeve), after deformation.

FIGS. 6A-6G schematically illustrate tube shape as it changes at different points in the shaping process.

FIG. 7 schematically illustrates the shape of a possible support structure or platform for supporting a glass tube before, during, and after deformation.

FIG. 8 schematically illustrates a possible layout for an in-line manufacturing process according to the present disclosure.

The following reference characters are used in this specification:
10 Glass tube
12 Glass sleeve
14 Inner curved surface (of 10)
16 Space (within 10)
22 One or more shaping tools
23 Generally D-shaped cross-section (of 22)
24 One or more shaping tools
25 Modified rectangular cross-section (of 24)
30 Flattened portion (of 12)
32 Flattened portion (of 12)
34 Flattened portion (of 12)
36 Flattened portion (of 12)
40 Curved portion (of 12)
42 Curved portion (of 12)
50 Support structure
52 One or more openings (within 50)
60 Loading zone
62 Heating zone
64 Deforming (or reforming) zone
66 Controlled cooling zone
68 Unloading zone
70 Front portion (of 23)
71 Back portion (of 23)
72 Side portion (of 23)
74 Side portion (of 23)
76 Following portion (of 23)
78 Following portion (of 23)
80 Non-circular cross-section (of 12)
82 Length (of 12)
84 Internal opening (of 12)
86 Glass thickness (of 12)
90 Curved corner (of 25)
92 Curved corner (of 25)

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, numerous specific details are set forth in order to provide a thorough understanding of the present invention. However, it will be clear to one skilled in the art when the present invention can be practiced without some or all of these specific details. In other instances, well-known features or processes may not be described in detail so as not to unnecessarily obscure the invention. In addition, like or identical reference numerals may be used to identify common or similar elements.

A high quality monolithic glass sleeve is provided, where the front side of the glass sleeve optionally can serve as the front cover and the back side of the glass sleeve optionally can serve as the back cover for an electronic device. The monolithic glass sleeve can have a cross-sectional profile that can accommodate a flat display. In general, this cross-sectional profile can have flat sides that can be arranged in parallel to the flat display. The flatness of the flat sides optionally can be configured to meet stringent requirements specified by the electronic device manufacturers.

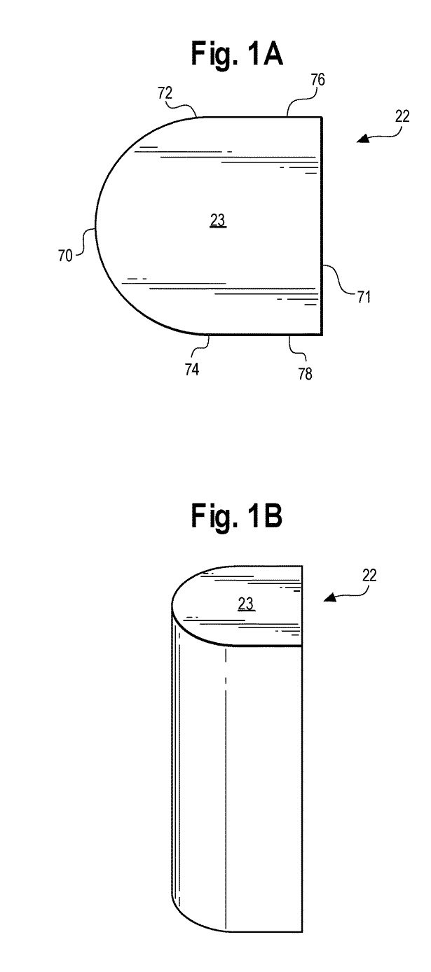

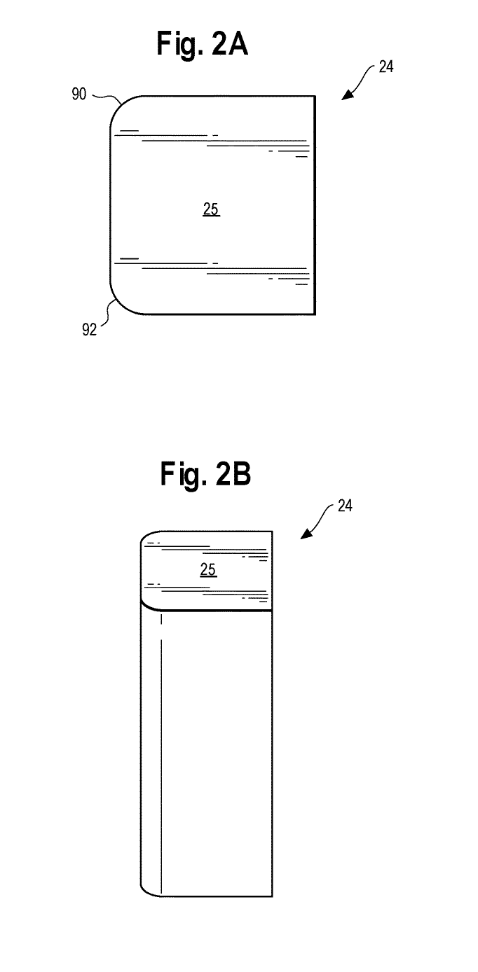

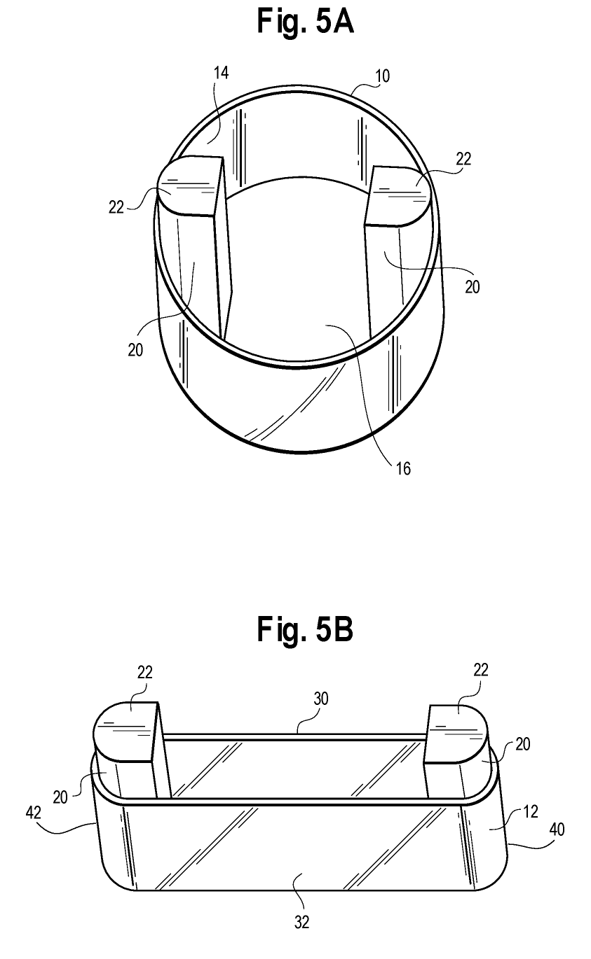

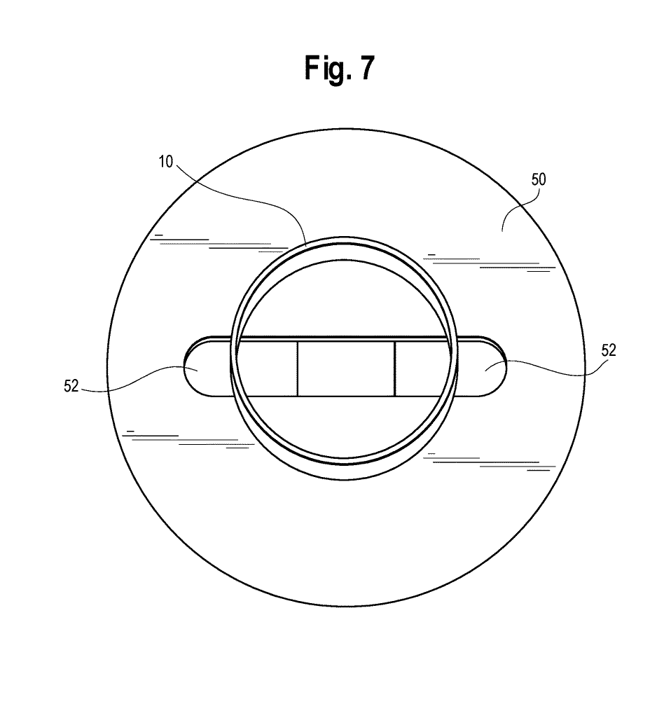

FIGS. 1A, 1B, 2A, and 2B, illustrate shaping tools 22 and 24 of the present disclosure for deforming a tube 10 (shown in FIG. 5A and FIG. 7) made of a glass material. The glass material will typically be glass and in the form of a substantially round-section cylindrical tube 10. The one or more shaping tools 22 or 24 can be formed of any suitable material, such as: steel coated with boron nitride, air bearings (optionally sintered air bearings made of a refractory material, for example graphite or carbon), a nickel-based alloy (e.g., Inconel), or another material. Optionally, the shaping tool material can be a material that will introduce few defects into the glass material during contact between the shaping tool 22 and 24 and the glass tube 10. In addition, the shaping tool material selected optionally has a coefficient of thermal expansion similar to or higher than the glass material, or otherwise is arranged (as in the case of an air bearing) to ensure that the glass does not shrink sufficiently to introduce stresses in the glass or to deform or otherwise interfere with one or more shaping tools 22 or 24 as the glass cools after deformation. The shaping tool material optionally has sufficiently high thermal properties that it will not substantially deform or be degraded at the temperatures used to deform the glass tube 10. As one particular example, if a shaping tool 22 or 24 is an air bearing made of graphite or carbon, care should be taken that the gas used in the air bearing does not support undue oxidation of the graphite or carbon under the temperature and other conditions encountered by the shaping tool 22 or 24.

Optionally, the glass tube 10 can be made from an ion-exchangeable glass. Optionally, an ion-exchangeable glass will contain relatively small alkali metal or alkaline-earth metal ions that can be exchanged for relatively large alkali or alkaline earth metal ions. An ion-exchangeable glass can be alkali-aluminosilicate glass or alkali-aluminoborosilicate glass. Examples of ion-exchangeable glass can be found in the patent literature, e.g., U.S. Pat. No. 7,666,511 (Ellison et al., Nov. 20, 2008) U.S. Pat. No. 4,483,700 (Forker, Jr. et al., Nov. 20, 1984), and U.S. Pat. No. 5,674,790 (Araujo, Oct. 7, 1997), all incorporated by reference in their entireties, and are also available from Corning Incorporated under the trademark GORILLA® glass.

Optionally, a substantially cylindrical glass tube 10 can be provided. The glass tube 10 can be polished or otherwise treated to reduce or remove interior imperfections. The glass tube 10 can be heated to its softening point. The softening point can be, for example, the dilatometric softening point or the Littleton softening point. One or more shaping tools 22 or 24 can then be introduced into the space 16 within the inner curved surface 14 of the glass tube 10, and moved against the inner curved surface 14 to deform the glass tube 10 and form a first flattened portion 30. Optionally, to form a glass sleeve 12, two shaping tools 22, 22 or 24, 24 can be introduced into the space 16 and moved apart from each other and against two opposing contact portions on the inner curved surface 14 of the glass tube 10. Optionally, two opposing flattened portions 30,32 will be formed.

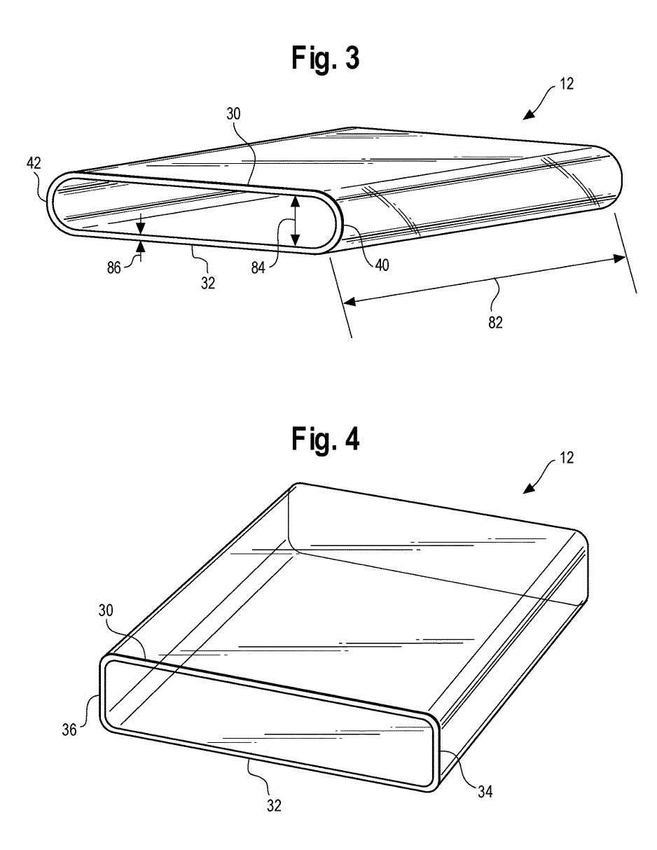

As used in the present disclosure, the term “sleeve” is used to describe a three-dimensional (3D), tubular substrate having a non-circular cross-section 80. Exemplary glass sleeves 12 are depicted in FIGS. 3 and 4. Optionally, a glass sleeve 12 can have a cross-section that is either somewhat oval or somewhat-rectangular with rounded edges. Optionally, a glass sleeve 12 can comprise a length 82, an internal opening 84, and a glass thickness 86. Optionally, a glass sleeve 12 can have at least one flattened portion 30 that is, or approaches being, optically flat.

Optionally, the one or more shaping tools 22 or 24 can have a generally D-shaped cross-section 23, as depicted in FIGS. 1A and 1B. The generally D-shaped cross-section 23 can comprise a generally half-cylindrical, convex front portion 70 mounted for movement against the inner curved surface 14. The generally D-shaped cross-section 22 can also comprise circumferentially spaced, axially extending first 72 and second 74 side portions on opposite sides of the front portion 70, a first following portion 76 extending back from the first side portion 72 along a plane generally parallel to the direction of movement of the front portion 70, and a second following portion 78 extending back from the second side portion 74 generally parallel to the direction of movement of the front portion 70. A back portion 71 can be straight, as shown in FIGS. 1A and 1B, as in a letter “D;” it also can be curved or otherwise shaped and still be “generally D-shaped” as defined here, as it does not normally come in contact with the glass tube 10. One advantage of a generally D-shaped cross-section 23 can include prevention of sagging of the glass tube 10 adjacent to the following portions 76 and 78 during deformation. Such sagging can produce a dog-bone shaped sleeve, which may be undesirable if not intended. Another advantage of a generally D-shaped cross-section 23 can include that it is readily possible to form a glass sleeve 12 having a pair of opposing curved portions 40, 42. Optionally, the pair of opposing curved portions 40, 42 can be substantially semi-circular.

FIG. 3 shows a glass sleeve 12 that can be formed using the one or more shaping tools 22 (optionally two) depicted in FIGS. 1A and 1B.

FIG. 5A shows a schematic of two shaping tools with generally D-shaped cross-sections 23 positioned against the inner curved surface 14 of a glass tube 10 prior to deformation. FIG. 5B shows a schematic of the two shaping tools with generally D-shaped cross-sections 22 bearing against the inner curved surface 14 of a glass tube 10 (now in the form of a glass sleeve 12) after deformation.

Optionally, the one or more shaping tools 22 or 24 can have a modified rectangular cross-section 25 with two curved corners 90, 92, for example the shaping tool 24 depicted in FIGS. 2A and 2B. One advantage of a tool 24 having a modified rectangular cross-section 25 can include prevention of sagging of the glass tube 10 during deformation. Another advantage of a modified rectangular cross-section 25 can include that it is readily possible to form a glass sleeve 12 having two pairs of opposing flattened portions 30, 32 and 34, 36.

FIG. 4 shows a glass sleeve 12 that can be formed using the one or more shaping tools 24 (optionally two) depicted in FIGS. 2A and 2B.

Optionally, the first flattened portion 30, second flattened portion 32, and other flattened portions 34, 36, of a glass sleeve 12 can be optically flat or nearly so. For example, the deviation in flatness can be ±50 μm across a 6 cm long first flattened portion 30 of a glass sleeve 12. The deviation in flatness can be measured by, for example, scanning confocal microscopy.

Optionally, the thickness of a glass sleeve 12 across a first flattened portion 30 can be carefully maintained such that the thickness does not vary by more than be ±50 μm across a 6 cm long first flattened portion 30 of a glass sleeve 12.

Optionally, the distance between two opposing flattened portions 30, 32 of a glass sleeve 12 across the length of the opposing flattened portions 30, 32 can be carefully maintained such that the distance between two opposing flattened portions 30, 32 does not vary by more than ±100 μm across a 6 cm long pair of two opposing flattened portions 30, 32 of a glass sleeve 30, 32.

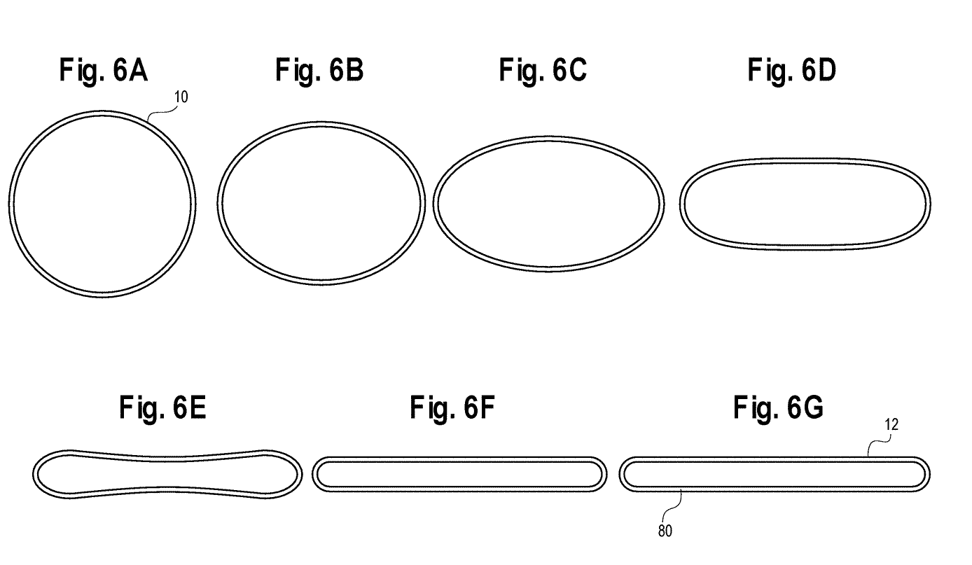

Optionally, FIGS. 6A to 6G provide a schematic illustration of the changing shape of a glass tube 10 as it is deformed into a glass sleeve 12. FIG. 6A represents the glass tube 10 in its substantially cylindrical form prior to deformation. FIG. 6G represents a glass tube 10 that has been deformed into a glass sleeve 12. FIGS. 6B through 6F show the shape of the glass tube 10 as it is deformed from being substantially cylindrical into being a glass sleeve 12.

Optionally, the one or more shaping tools 22 or 24 can be moved against the inner curved surface 14 such that a constant force can be applied by the one or more shaping tools 22 or 24 to the inner curved surface 14. The speed at which the one or more shaping tools 22 or 24 can be moved against the inner curved surface 14 can vary. It may be important to keep applied force beneath a critical level to prevent breaking the glass.

The force required to shape the inner curved surface 14 has been observed to be lower in a bending phase early in the process, when the primary shaping is straightening the curved perimeter between two shaping tools 22 and bending the curved perimeter around a shaping tool 22 without substantially increasing its circumference, than in a later stretching phase in the process when stretching the perimeter and thus increasing its circumference. Thus, the force profile or rate of travel applied to the one or more shaping tools 22 or 24 can be modified when transitioning from the bending phase to the stretching phase of the process.

Optionally, the one or more shaping tools 22 or 24 can be moved against the inner curved surface 14 at a constant speed. Optionally, the force that can be applied by the one or more shaping tools 22 or 24 to the inner curved surface 14 can vary. It can be important to keep applied force beneath a critical level to prevent breaking the glass.

Although it is possible to deform the glass tube 10 while held substantially horizontal, optionally the substantially cylindrical glass tube 10 will be deformed while held substantially vertical (i.e., with the cylindrical axis vertical) to minimize glass sagging. One possible support structure (or platform) 50 for supporting a glass tube 10 in a vertical position is depicted in FIG. 7. Such a support structure 50 can have one or more openings 52 to allow entry and optionally movement of one or more shaping tools 22 or 24. The support structure 50 shown in FIG. 7 has two openings 52, 52 to allow entry of two shaping tools, e.g., 22, 22. A support structure 50 can be made of a material with sufficient thermal properties to withstand the heating and cooling that occurs during the process of deforming the glass tube 10.

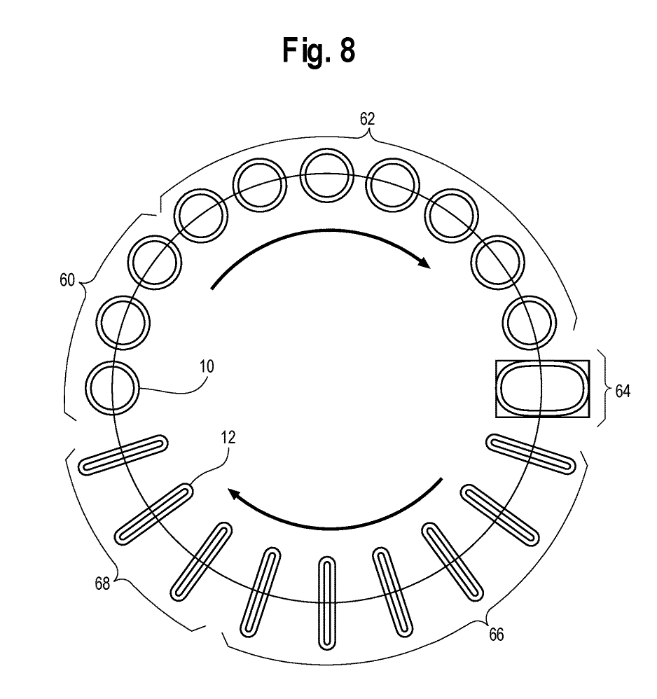

Optionally, a series of glass tubes 10 can be arranged vertically in an in-line manufacturing process as shown in FIG. 8 that can comprise five zones: (1) a loading zone 60; (2) a heating zone 62; (3) a deforming (or reforming) zone 64; (4) a controlled cooling zone 66; and (5) an unloading zone 68, as represented schematically in FIG. 8. Optionally, substantially cylindrical glass tubes 10 can, in or prior to the loading zone 60, be loaded onto a support structure 50 (such as the support structure 50 depicted in FIG. 7). The glass tubes 10 can move sequentially into a heating zone 62, during which point the glass tubes 10 are heated to or above their glass softening point. The glass tubes 10 can then move sequentially into the deforming (or reforming) zone 64, where one or more shaping tools 22 or 24 can be introduced to deform (or reform) the glass tubes 10 into glass sleeves 12. Next, the glass tubes 10 (now glass sleeves 12) can move sequentially into a controlled cooling zone 66, where the temperature is carefully controlled. Once the glass sleeves 12 have cooled to a sufficiently low temperature, they can move into the unloading zone 68 to be unloaded.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims.

1. A method for producing a glass sleeve with a first flattened portion comprising:
a. providing a substantially cylindrical tube made of glass, the substantially cylindrical tube having a longitudinal axis and an inner curved surface enclosing a space;
b. heating the substantially cylindrical tube to a temperature within the softening range of the glass;
c. introducing one or more shaping tools having a generally D-shaped or generally rectangular cross-section into the enclosed space;
d. moving the one or more shaping tools against the inner curved surface to deform the tube, forming the first flattened portion.

2. The method of claim 1, comprising introducing at least two of the shaping tools into the enclosed space and moving the at least two shaping tools apart from each other and against the inner curved surface.

3. The method of claim 1, further comprising forming a second flattened portion opposing the first flattened portion.

4. The method of claim 3, further comprising moving the one or more shaping tools having a generally rectangular cross-section against the inner curved surface to deform the tube, forming a further two opposing flattened portions.

5. The method of claim 1, further comprising moving the one or more shaping tools having a generally D-shaped cross-section against the inner curved surface to deform the tube, forming two opposing curved portions.

6. The method of claim 5, wherein the two opposing curved portions are substantially semi-circular.

7. The method of claim 1, wherein the substantially cylindrical tube is heated to a temperature exceeding the dilatometric softening point of the glass.

8. The method of claim 1, wherein the substantially cylindrical tube is heated to a temperature exceeding the Littleton softening point of the glass.

9. The method of claim 1, wherein the substantially cylindrical tube is heated to a temperature such that the glass viscosity is 10⁷-10^{9.5} P (poise).

10. The method of claim 1, wherein the substantially cylindrical tube has a length along the longitudinal axis and the one or more shaping tools having a generally D-shaped cross-section are moved against the inner curved surface at a force of 0.5-10.0 N per cm length of the substantially cylindrical tube.

11. The method of claim 1, wherein one or more shaping tools are made from steel coated with boron nitride.

12. The method of claim 1, wherein one or more shaping tools are made from porous carbon air bearings.

13. The method of claim 1, wherein one or more shaping tools are made from porous graphite air bearings.

14. The method of claim 1, wherein one or more shaping tools are made from a nickel-based alloy.

15. The method of claim 14, wherein one or more shaping tools are made from Inconel.

16. The method of claim 1, in which the generally D-shaped cross-section comprises:
a. a generally half-cylindrical, convex front portion mounted for movement against the inner curved surface;
b. circumferentially spaced, axially extending first and second side portions on opposite sides of the front portion;
c. a first following portion extending back from the first side portion along a plane generally parallel to the direction of movement of the front portion; and
d. a second following portion extending back from the second side portion along a plane generally parallel to the direction of movement of the front portion.

17. A glass sleeve comprising a substantially rectangular or substantially oval cross-section, a length, an internal opening, and a glass thickness, the cross-section having at least a first flattened portion, wherein the flatness of the first flattened portion does not deviate by more than 50 μm across the length.

18. The glass sleeve of claim 17, wherein the glass thickness does not vary by more than 50 μm across the first flattened portion.

19. The glass sleeve of claim 17, wherein the internal opening does not vary by more than 100 μm across the first flattened portion.

20. The glass sleeve of claim 17, in which the cross-section further comprises a second flattened portion opposing the first flattened portion to define a first pair of opposing flat portions.

21. The glass sleeve of claim 20, in which the cross-section further comprises a second pair of opposing substantially flat portions.

22. The glass sleeve of claim 17 in which the cross-section further comprises a pair of opposing curved portions.
